(19) United States
(12) Patent Application Publication
(10) Pub. No.: US 2012/0030470 A1
(43) Pub. Date: Feb. 2, 2012

(54) WIRELESS PROGRAMMING OF VEHICLE MODULES

(75) Inventors: Dmitri Jdanov, Windsor (CA); Chan Wing Yung, Auburn Hills, MI (US)

(73) Assignee: GENERAL MOTORS LLC, Detroit, MI (US)

(21) Appl. No.: 12/846,093

(22) Filed: Jul. 29, 2010

(51) Int. Cl. H04W 12/06

(52) U.S. Cl. 713/176

(57) ABSTRACT

A system and method for programming a vehicle module via a secure local area wireless connection. The method carried by the system involves establishing a wireless connection between a vehicle telematics unit and a dealership wireless node. Then, the dealership sends via the wireless node a digital certificate to the vehicle telematics unit. The vehicle uses the digital certificate to verify that the dealership is authorized to provide the vehicle with an upgrade to one or more of the vehicle's components. In response of the verification, an upgrade is performed to one or more vehicle components via the wireless communication.

### TECHNICAL FIELD

The present invention generally relates to vehicle modules programming and, more particularly, to methods for wireless programming of vehicle modules.

### BACKGROUND

Many on-board vehicle systems today utilize firmware or other software stored at particular devices in the vehicle. Due to technological advances, recalls, paid service subscription, etc., these vehicle components may require a software upgrade, and this can be done during a visit to a dealership. One way in which this can be done is by physically connected to the vehicle or the vehicle component itself and providing the new programming. Vehicle telematics units make it possible to at least partially automate this process in a wireless manner that does not require making a physical connection to the vehicle. However, proper vehicle identification, security, and authenticity should be ensured to prevent problems in upgrading due to inadvertent errors as well as intentional fraud or malfeasance.

### SUMMARY OF THE INVENTION

According to one embodiment, there is provided a method of upgrading a vehicle component via wireless communication, comprising the steps of: (a) establishing a wireless connection directly between a vehicle telematics unit and a dealership wireless node; (b) receiving at the telematics unit a digital certificate for the dealership that is sent from the wireless node; (c) verifying via the digital certificate that the dealership is authorized to provide the vehicle with an upgrade to one or more of the vehicle's components; and, in response to the verification, and (d) upgrading the one or more vehicle components via the wireless connection.

According to another embodiment, there is provided a method of upgrading a vehicle component via wireless communication, comprising the steps of: (a) detecting a vehicle telematics unit in a dealership wireless hotspot zone; (b) sending a digital certificate to the vehicle telematics unit via wireless communication from the dealership; (c) verifying via the digital certificate that the dealership is authorized to provide the vehicle with an upgrade to one or more of the vehicle's components; and, in response to the verification, and (d) sending one or more update packages to upgrade one or more vehicle components via a secure communication established using the digital certificate.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein; and

FIG. 2 is a flowchart depicting one embodiment of a method of wireless programming of vehicle modules that may be used with the exemplary system shown in FIG. 1.

### DETAILED DESCRIPTION OF THE PREFERRED EMBODIMENTS

The system and method described below are directed to different embodiments of an approach for a wireless programming of a vehicle module. The disclosed methods provide a wireless programming mechanism which involves establishing a wireless connection between a vehicle telematics unit and a dealership wireless node. Then, the vehicle telematics unit receives a digital certificate for the dealership which is sent via the wireless connection. Next, the digital certificate is verified to determine whether the dealership is authorized to provide the vehicle with an upgrade to one or more of the vehicle's components. If so, then any needed or desired upgrades is then performed via the wireless connection. The approach allows the system to restrict automatic, wireless vehicle programming to only those dealerships and other entities authorized to do so.

### Communications System—

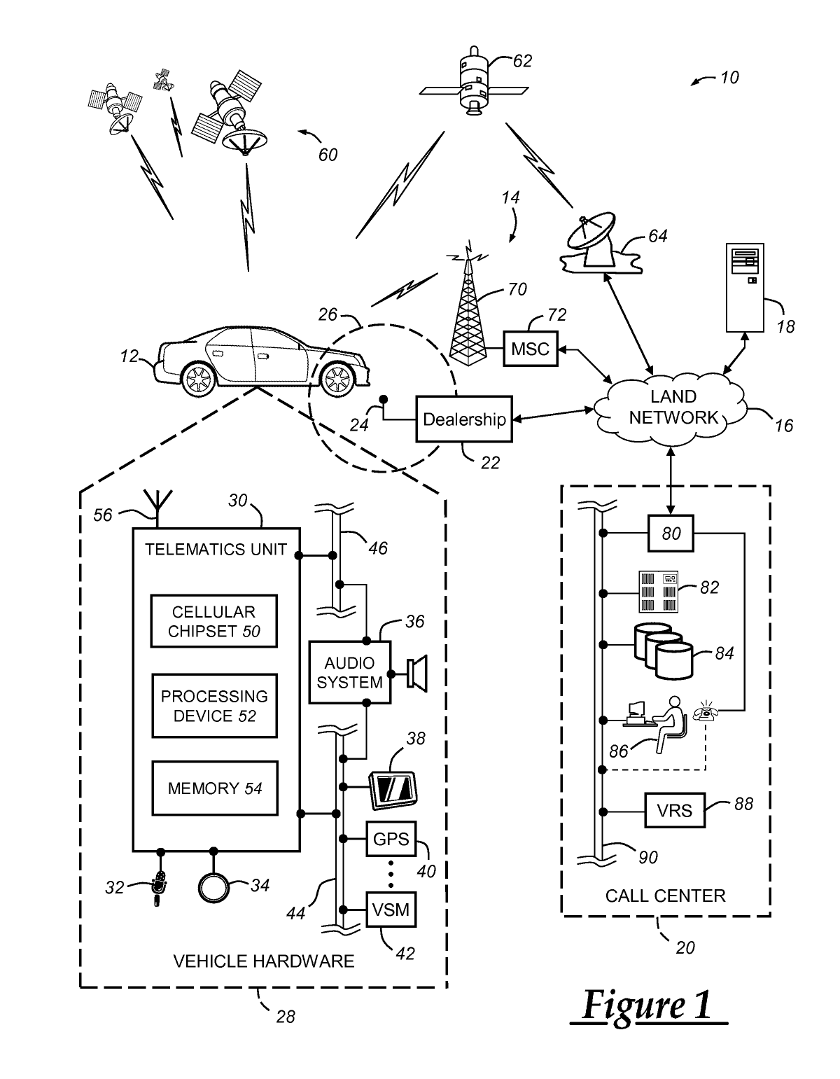

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, a computer 18, a call center 20, and a dealership 22. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is an OEM-installed device that enables wireless voice and/or data communication over wireless carrier system 14 and via wireless networking so that the vehicle can communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live adviser or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle 12 and dealership 22 or other networked devices can also be carried out using telematics unit 30. For this purpose, telematics unit 30 can be configured to communicate wirelessly according to one or more wireless protocols, such as WiFi (e.g., any of the IEEE 802.11 protocols), WiMAX, or Bluetooth. When used for packet-switched data communication such as TCP/IP, the telematics unit can be configured with a static IP address or can set up to automatically receive an assigned IP address from another device on the network such as a router or from a network address server.

To establish a WiFi or other wireless connection between the vehicle 12 and dealership 22, a wireless node 24 can be maintained by the dealership. The wireless node 24 provides a wireless hotspot 26 comprising a zone of wireless coverage that includes some if not all of the dealership premises so that a vehicle located at the dealership (e.g., within the dealership parking lot and/or within a service bay at the dealership) will be able to detect the wireless node 24 and connect to it via the telematics unit 30. This wireless node 24 can be part of an internal network at the dealership that is connected to the land communication network 16. In other embodiments, the vehicle 12 can include a wireless node and associated hotspot to which a dealership computer can connect. Alternatively or additionally, communication between the vehicle and dealership can be by way of a peer-to-peer wireless connection.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20, dealership 22, or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20 and dealership 22. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 and dealership 22 need not be connected via land network 16, but could include wireless telephony equipment so that one or both of these facilities can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer at the dealership 22 where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Where the computer 18 is used by a subscriber or other user to access telematics services, it can be implemented using any suitable type of computer (e.g., a desktop computer or portable computer). In this regard, computer 18 is used as a processing device located remotely of the vehicle, even though as a portable computer it may occasionally be located at the vehicle.

Call center 20 is designed to provide the vehicle electronics 28 with a number of different system back-end functions and, according to the exemplary embodiment shown here, generally includes one or more switches 80, servers 82, databases 84, live advisers 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live adviser phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live adviser 86, it will be appreciated that the call center can instead utilize VRS 88 as an automated adviser or, a combination of VRS 88 and the live adviser 86 can be used.

Call center 20 can also communicate with the dealership 22 for various purposes, such as to provide firmware and other software updates to the dealership for use in providing new programming, calibration data, or other enhancements or fixes to one or more of the VSMs in the vehicle 12. This can also be used to permit reporting back to the call center of information concerning vehicle servicing, such as to report a successful installation of an update made to one or more of the VSMs.

### Method—

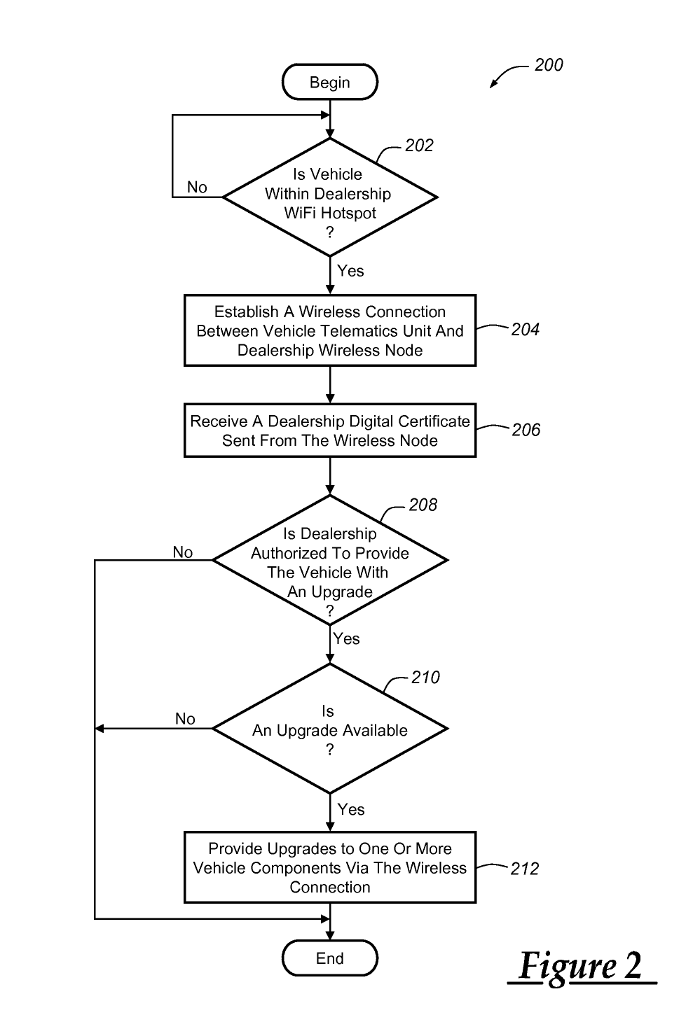

Turning now to FIG. 2, there is shown a method 200 for upgrading a vehicle component via wireless communication. This method is merely illustrative of one embodiment and many others will become apparent to those skilled in the art. The method 200 starts at step 202 and begins by checking if the vehicle is within a dealership WiFi hotspot. A WiFi hotspot can be broadly described as a wireless access point of a network such as a wireless local area network (WLAN) commonly associated with IEEE 802.11 technology (e.g., 802.11a/b/g/n, etc.). In one embodiment, the vehicle telematics unit 30 detects a signal from the dealership node 24 and attempts to connect to a dealership network. Then, a dealership firewall will recognize that a wireless unit is trying to connect to its network. In another embodiment, the telematics unit can be configured as a wireless node or hotspot in which case the dealership can detect a signal broadcast from the telematics unit 30. Then, a dealership software application recognizes that a vehicle network is in its vicinity. Or, in another embodiment, a peer-to-peer connection can be established between the two. In any case, a media access control (MAC) address or one or more other parameters can be sent and recognized by the dealership system, for example, to determine that the vehicle is in the dealership WiFi hotspot. These are only some of possible implementations as others are possible. As discussed above, the system described herein is not limited to a WiFi system as skilled artisans will recognize that other wireless systems are also possible. For instance, wireless and cellular general packet radio service (GPRS) system, wireless personal area network (WPAN) (e.g., 802.15), WiMAX (e.g., 802.16), or any other wireless technology or protocol used by the telematics unit 30 can be employed. At step 202, if there is no vehicle within the dealership WiFi hotspot 26 then the method keeps checking for a vehicle within a dealership WiFi hotspot; however, if a vehicle is within a dealership WiFi hotspot then, method 200 proceeds with the next step.

At step 204, a wireless connection is established between the vehicle telematics unit 30 and a dealership wireless node 24. This can be done using any of the vehicle-to-dealership communication approaches discussed above. Moreover, where a dealership wireless network is used, any of several techniques can be employed to provide a connection. In one embodiment, a mesh wireless network can be used involving a series of radio transmitters communicating with each other and creating a cloud of radio signal coverage area. In this case, a protocol that controls the mesh may determine the best path for the connection to take place and the data to follow. The protocol may plan the route that will make the fewest hops (e.g., signal hops from one receiver to another) before reaching a wired connection or a backhaul node (e.g., point to point, point to multipoint, etc.). Then, the data travels over the Internet to reach its final destination. In a second embodiment, a mesh enabled architecture (MEA) can be employed to provide a connection. In this case, MEA creates an ad-hoc network and allows multi-hopping where a signal moves from a vehicle to another in the network rather than from a vehicle to a node in the network. Hence, the vehicles make connections to each other and create a network by acting as routers or repeaters to pass the signal. In a third embodiment, a hub and spoke network can be employed to make a connection. In this case, the hub can be the dealership which sends and receives data to several vehicles (spokes). Skilled artisans will recognize that other techniques can be employed, for example, WiFi Direct can be also used to list but one example. Furthermore, a wireless router, associated with the dealership network, can have a physical connection to the Internet via a wire (e.g., via land network 16), through which it can receive new programming or data for the vehicle and can report the successful programming of the vehicle following step 212 of the method.

Once the wireless connection is established between the telematics unit 30 and wireless node 24, then at step 206 the telematics unit receives a dealership digital certificate sent from the wireless node. For several purposes including identification and security, the vehicle-dealership communication involves one or more security and identification measures. One or more of several techniques can be employed, for example, a digital certificate issued by a certification authority (CA) or others and containing a set of credentials including a key certificate (e.g., X.509), a private key, a shared key, etc. can be used. Then, the vehicle can verify the authenticity of the certificate. In addition, other security measures including service set identifier (SSID), wired equivalent privacy (WEP) key, WiFi protected address (e.g., WPA, WPA2, etc.), WMM, virtual private network (VPN), firewall, media access control (MAC) address filtering, username, password, can be taken instead or in parallel. Furthermore, the dealership may also identify the vehicle location as a security measure. In one embodiment, MEA techniques including triangulation is used to measure time of flight of a traveling signal between three nodes. In another embodiment, vehicle GPS can be used to locate the vehicle. In any case, the security measures discussed herein and others are employed in order to establish a secure communication between the vehicle and the dealership.

At step 208, the digital certificate validity is checked. One or more checks are performed here to verify the dealership credential authenticity, prevent fraud, etc. In one embodiment, processing device 52 verifies the dealership credential including MAC address against data stored in memory 54. In another embodiment, telematics unit 30 initializes a call to call center 20 to verify the dealership credential. Skilled artisans will recognize that other techniques can be implemented. Assuming the digital certificate is valid then method 200 proceeds to the next step. However, if the digital certificate is not valid then method 200 ends the process.

At step 210, the method checks if a software upgrade is available. This step may require checking one or more vehicle system modules (VSMs) software versions and comparing them to the dealership available software. In one embodiment, processing device 52 sends a software inquiry directly to one or more VSMs 42 about their current software versions. In a second embodiment, processing device 52 retrieves the software versions for one or more VSMs from memory 54 where they are stored. Later, in one embodiment, the vehicle may send the software versions information to a dealership via a secure communication using the digital certificate. Then, the dealership decides whether to upgrade the software of one or more VSMs. In another embodiment, the vehicle telematics unit receives the latest software versions for one or more VSMs from the dealership via a secure communication using the digital certificate. Then, the vehicle decides, for example, via its processing device 52 whether to upgrade one or more VSMs' software. In this case, the vehicle may present to a vehicle driver via audio system 36, visual system 38, etc. an option to allow a software upgrade. This can be beneficial if the vehicle driver installed an aftermarket or custom vehicle component, and/or downloaded a software. In any case, if an upgrade is available then method 200 proceeds to the next step; however, if there is no upgrade available or desired then the process ends.

Finally, method 200 proceeds to step 212 where the software (e.g., firmware) of one or more VSMs is upgraded via a secure wireless communication. In one embodiment, processing device 52 receives one file containing several VSM software upgrades. In another embodiment, processing device 52 receives one VSM upgrade at a time. Later, processing device 52 may select to upgrade one VSM at a time, two or more simultaneously, or at any other suitable order. Once the upgrade is performed, the secure communication session between the vehicle and the dealership is ended. Any handshake algorithm may be implemented here including a satisfactory acknowledgement sent by the dealership to the vehicle or vice versa to signal the end of the communication. Method 200 may optionally provide a vehicle driver, dealership technician, etc. with the status (e.g., in process, successful, unsuccessful, etc.) of the upgrade via audio system 36, and/or video system 38, for example. In addition, the vehicle may record in its system the new software version, date of update, location of update, and/or other applicable data. The recording can be done centrally within the via or more locally on the vehicle, such as at the particular VSM upgraded. In one embodiment, processing device 52 records the upgrades in a central location such as, for example, memory 54. In another embodiment, processing device 52 records the upgrade at each VSM upgraded. In a third embodiment, processing device 52 records the upgrade at each VSM upgraded if possible and at memory 54 if it is not possible to record the upgrade at the corresponding VSM. Additionally or in lieu of this recording at the vehicle, the upgrade information (status, software version, and/or other information) can be stored remotely at the call center 20, dealership 22, or other location.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, control of upgrading of the VSMs can be handled by an on-board device other than the telematics unit itself. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of upgrading a vehicle component via wireless communication, comprising the steps of:
(a) establishing a wireless connection directly between a vehicle telematics unit and a dealership wireless node;
(b) receiving at the telematics unit a digital certificate for the dealership that is sent from the wireless node;
(c) verifying via the digital certificate that the dealership is authorized to provide the vehicle with an upgrade to one or more of the vehicle's components; and, in response to the verification,
(d) upgrading the one or more vehicle components via the wireless connection.

2. The method of claim 1, wherein the wireless communication utilizes WiFi technology.

3. The method of claim 1, wherein step (a) further comprises detecting the dealership wireless node from a list of dealership hotspot MAC addresses residing at the vehicle telematics unit.

4. The method of claim 3, further comprising the step of downloading the list of dealership hotspot MAC addresses to the vehicle telematics unit from a call center.

5. The method of claim 1, further comprising the step of storing the digital certificate at the dealership.

6. The method of claim 1, wherein step (c) further comprises the steps of: determining the software version of one or more vehicle components by the vehicle telematics unit, sending the information to the dealership, and deciding to upgrade one or more vehicle components by the dealership.

7. The method of claim 1, wherein step (c) further comprises the steps of: determining the software version of one or more vehicle components by the vehicle telematics unit, receiving one or more vehicle components latest software versions, and requesting an upgrade to one or more components from the dealership.

8. The method of claim 1, wherein step (d) further comprises sending a software upgrade to the vehicle via a secure communication using the digital certificate.

9. The method of claim 8, further comprises the steps of: sending the status of the upgrade to the dealership, and ending the secure communication once a satisfactory acknowledgement is sent by the dealership.

10. A method of upgrading a vehicle component via wireless communication, comprising the steps of:
(a) detecting a vehicle telematics unit in a dealership wireless hotspot zone;
(b) sending a digital certificate to the vehicle telematics unit via wireless communication from the dealership;
(c) verifying via the digital certificate that the dealership is authorized to provide the vehicle with an upgrade to one or more of the vehicle's components; and, in response to the verification,
(d) sending one or more update packages to upgrade one or more vehicle components via a secure communication established using the digital certificate.

11. The method of claim 10, wherein step (c) further comprises the steps of: determining the software status of one or more vehicle components by the vehicle telematics unit, sending the information to the dealership, and deciding to upgrade one or more vehicle components by the dealership.

12. The method of claim 10, wherein step (d) further comprises the steps of: sending the status of the upgrade to the dealership, and ending the secure communication once a satisfactory acknowledgement is sent by the dealership.
